(19) United States
(12) Patent Application Publication
(10) Pub. No.: US 2024/0150017 A1
(43) Pub. Date: May 9, 2024

(54) Hanging structure and unmanned aerial vehicle hanging system

(71) Applicant: Coretronic Intelligent Robotics Corporation, Hsin-Chu (TW)

(72) Inventors: TAI-YUAN WANG, Hsin-Chu (TW); I-TA YANG, Hsin-Chu (TW); YING-CHIEH CHEN, Hsin-Chu (TW)

(21) Appl. No.: 18/386,612

(22) Filed: Nov. 3, 2023

(30) Foreign Application Priority Data
Nov. 4, 2022 (TW) 111142192

(51) Int. Cl. B64D 1/22

(52) U.S. Cl. CPC B64D 1/22

(57) ABSTRACT

A hanging structure applicable to an unmanned aerial vehicle includes a hook-shaped body and at least one hook claw. The hook-shaped body has a bottom, at least one pivoting end, and an abutting portion. A hook opening is provided between the at least one pivoting end and the abutting portion and is opposite to the bottom. In addition, the at least one hook claw has a pivoting portion, and a first claw portion and a second claw portion that extend from the pivoting portion, respectively. The pivoting portion is pivoted to the at least one pivoting end. The second claw portion is heavier than the first claw portion. When the hanging structure is in a hanging state, a first end of the first claw portion abuts against the abutting portion, and the hook opening is closed. An unmanned aerial vehicle hanging system including the above hanging structure is further provided.

### CROSS-REFERENCE TO RELATED APPLICATION

This application claims the priority benefit of Taiwan Application No. 111142192, filed on Nov. 4, 2022. The entirety of the above-mentioned patent application is hereby incorporated by reference herein and made a part of this specification.

### TECHNICAL FIELD

The disclosure relates to a hanging structure, and more particularly to a hanging structure and an unmanned aerial vehicle hanging system.

### BACKGROUND

Unmanned aerial vehicles (UAV) may be used in cooperation with different tools according to use requirements, for example, used in aerial photography, pesticide spraying, military harassment, transportation of disaster relief supplies, etc. It is well known that when an unmanned aerial vehicle is used for delivering a hanging object, a hanging object is generally hung with a hanging hook, but a hook opening of the hanging hook may be open during hanging. Therefore, for example, during loading and unloading, the risk that the hanging object is unhooked and falls due to floating of the hanging object when being struck, and the problem that the hanging hook hooks the hanging object again after the unmanned aerial vehicle is unloaded cannot be avoided.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

The disclosure provides a hanging structure, so that a hook opening is kept closed during hanging, a hanging object is not prone to unhooking, and the hanging object will not be hooked again after unloading.

The disclosure further provides an unmanned aerial vehicle hanging system, so that the hanging object is not easily unhooked when an unmanned aerial vehicle delivers the hanging object, and the hanging object will not be hooked again when the unmanned aerial vehicle retracts a hanging hook after unloading.

Other objectives and advantages of the disclosure may be further understood from the technical features disclosed in the disclosure.

To achieve one, part or all of the above objectives or other objectives, the hanging structure applicable to the unmanned aerial vehicle provided by the disclosure includes a hook-shaped body and at least one hook claw. The hook-shaped body has a bottom, at least one pivoting end, and an abutting portion, and a hook opening is provided between the at least one pivoting end and the abutting portion and is opposite to the bottom. In addition, the at least one hook claw has a pivoting portion, and a first claw portion and a second claw portion that extend from the pivoting portion, respectively, and the pivoting portion is pivoted to the at least one pivoting end. The second claw portion is heavier than the first claw portion. When the hanging structure is in a hanging state, a first end of the first claw portion abuts against the abutting portion, and the hook opening is closed. The disclosure further provides an unmanned aerial vehicle hanging system including the above hanging structure.

In an embodiment of the disclosure, the above second claw portion has a second end, and when the hanging structure is in a hanging state, the second end is located on an inner side of the bottom.

In an embodiment of the disclosure, the number of the above hook claws is two, the number of the pivoting ends is two, and the two second ends of the two hook claws extend towards each other to be connected.

In an embodiment of the disclosure, an overall width of the abutting portion of the above hook-shaped body is greater than an opening of a handle of a hanging object.

In an embodiment of the disclosure, when the above hanging structure is in an unhooking state, the first end of the first claw portion does not abut against the abutting portion and is adapted to make the hanging object leave the hanging structure from the hook opening.

In an embodiment of the disclosure, the above unmanned aerial vehicle hanging system includes the above hanging structure and a retracting and releasing apparatus, wherein the retracting and releasing apparatus includes a retracting and releasing mechanism and a connecting piece, the retracting and releasing mechanism is adapted to retract and release the connecting piece, and the connecting piece is connected to the hook-shaped body.

In an embodiment of the disclosure, the above retracting and releasing apparatus further includes a housing, a switch, and an anti-falling mechanism. The anti-falling mechanism and the retracting and releasing mechanism are arranged in the housing, the switch is arranged on one side of the housing that faces the hanging structure and is electrically connected to the retracting and releasing mechanism and the anti-falling mechanism, and when the retracting and releasing mechanism retracts the connecting piece to cause the hanging structure to trigger the switch, the retracting and releasing mechanism stops retracting the connecting piece, and the anti-falling mechanism prevents the hanging structure from falling.

In an embodiment of the disclosure, a first guide portion is arranged on the side of the above housing that faces the hanging structure, the hook-shaped body further has a second guide portion cooperating with the first guide portion, and the second guide portion is adjacent to the abutting portion.

In an embodiment of the disclosure, the above first guide portion is an elliptical recess, and the second guide portion is an elliptical bulge.

In an embodiment of the disclosure, the anti-falling mechanism includes an anti-falling member and a driving member, wherein the driving member is electrically connected to the switch and is adapted to drive the anti-falling member to move.

In the embodiment of the disclosure, the hanging structure in which the hook opening is kept closed during hanging is used, so that the hanging object is not prone to unhooking, and the hanging object will not be hooked again after unloading. In the unmanned aerial vehicle hanging system according to the embodiment of the disclosure, the above hanging structure is used, so that the hanging object is not easily unhooked when the unmanned aerial vehicle delivers the hanging object, and the hanging object will not be hooked again when the unmanned aerial vehicle retracts the hanging structure after unloading.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A and FIG. 1B are schematic diagrams of a hanging structure at different perspectives respectively according to an embodiment of the disclosure.

FIG. 2 is a schematic diagram of opening a hook opening of a hanging structure according to an embodiment of the disclosure.

FIG. 3 is a schematic diagram of a hanging structure in a hanging state according to an embodiment of the disclosure.

FIG. 4 is a schematic diagram of switching a hanging structure to be in an unhooking state according to an embodiment of the disclosure.

FIG. 5 is a schematic diagram of a hanging structure according to another embodiment of the disclosure.

FIG. 6 is a schematic diagram of a hanging structure according to another embodiment of the disclosure.

FIG. 7A and FIG. 7B are schematic diagrams of an unmanned aerial vehicle hanging system in a hook releasing state and a hook retracting state respectively according to an embodiment of the disclosure.

FIG. 8 is a schematic diagram of an unmanned aerial vehicle hanging system according to another embodiment of the disclosure.

FIGS. 9A to 9C are schematic diagrams of a goods delivery process of an unmanned aerial vehicle according to an embodiment of the disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

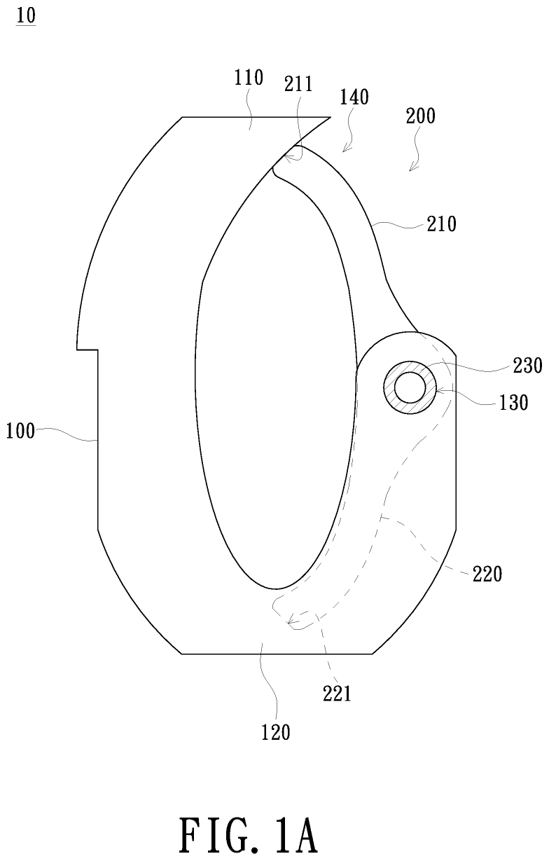

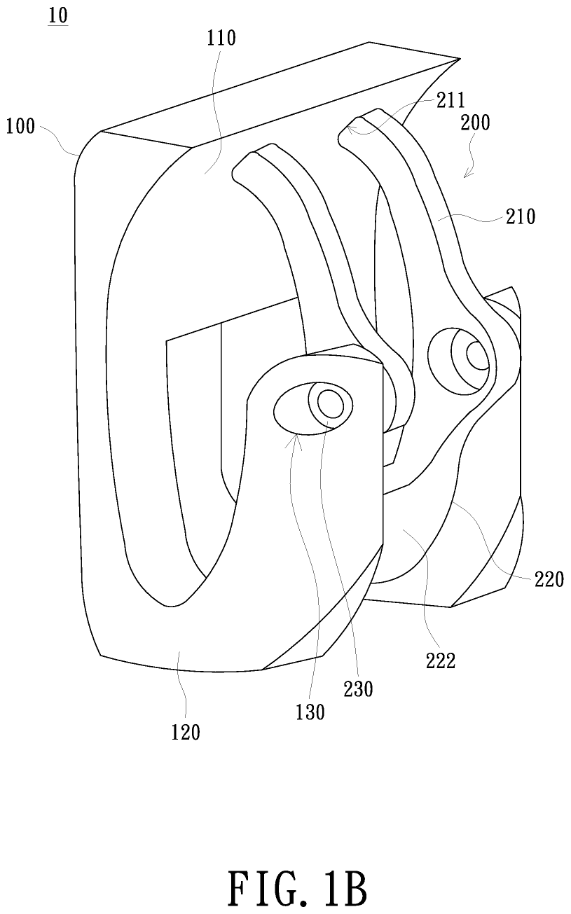

FIG. 1A and FIG. 1B are schematic diagrams of a hanging structure at different perspectives respectively according to an embodiment of the disclosure. Referring to FIG. 1A and FIG. 1B, the hanging structure 10 in this embodiment is applicable to an unmanned aerial vehicle, the hanging structure 10 includes a hook-shaped body 100 and at least one hook claw 200, and the hook-shaped body 100 has a bottom 120, at least one pivoting end 130, and an abutting portion 110. A hook opening 140 is provided between the pivoting end 130 and the abutting portion 110, and the hook opening 140 is opposite to the bottom 120. In addition, the hook claw 200 has a pivoting portion 230, and a first claw portion 210 and a second claw portion 220 that extend from the pivoting portion 230, respectively, and the pivoting portion 230 is pivoted to the pivoting end 130. The above second claw portion 220 has a second end 221. In this embodiment, for example, the number of hook claws 200 is two, the number of pivoting ends 130 is two, and the two second ends 221 of the two hook claws 200 extend towards each other to be connected. In other words, the two second ends 221 include a connecting portion 222 connected to each other. However, the disclosure does not limit the number of the hook claws 200 and the number of the pivoting ends 130, and does not limit the need to provide the connecting portion 222 between the plurality of adjacent second ends 221.

In this embodiment, the second claw portion 220 is heavier than the first claw portion 210. When the hanging structure 10 is in a hanging state, a first end 211 of the first claw portion 210 abuts against the abutting portion 110, and the hook opening 140 is closed. Specifically, the second claw portion 220 is heavier than the first claw portion 210. When the hanging structure 10 is in the hanging state, the second claw portion 220 is pulled by gravity to move downwards, to drive the hook claw 200 to rotate counterclockwise relative to the hook-shaped body 100, so that the first end 211 of the first claw portion 210 abuts against the abutting portion 110, and the hook opening 140 between the pivoting end 130 and the abutting portion 110 is closed. In other words, when the hanging structure 10 is in the hanging state, that is, the hanging structure 10 is hung up, no matter whether a weight is borne, the second claw portion 220 is pulled by the gravity to cause the first end 211 to abut against the abutting portion 110, and to cause the hook opening 140 to be closed. The second claw portion 220 of the hook claw 200 is heavier than the first claw portion 210 thereof. For example, the first and second claw portions may be made of a same material in design, but the second claw portion 220 is larger in size than the first claw portion 210, or the second claw portion 220 and the first claw portion 210 have the same material and size, but the first claw portion 210 is hollow. However, the disclosure is not limited thereto.

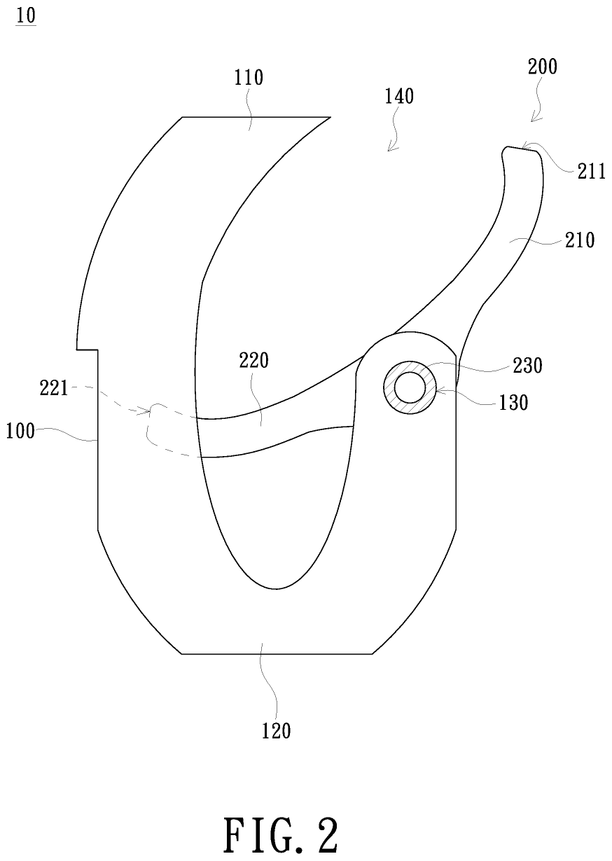

FIG. 2 is a schematic diagram of opening a hook opening of a hanging structure according to an embodiment of the disclosure. Referring to FIG. 2, when the hook opening 140 is to be opened, for example, the first end 211 of the hook claw 200 is manually moved in a direction opposite to the abutting portion 110, so that the hook claw 200 rotates clockwise relative to the hook-shaped body 100, to separate the first end 211 from the abutting portion 110. When the hook opening 140 is opened, a hanging object (not drawn in figure) adapted to cooperate with the hook opening 140 and the hook-shaped body 100 may be placed in the hanging structure 10.

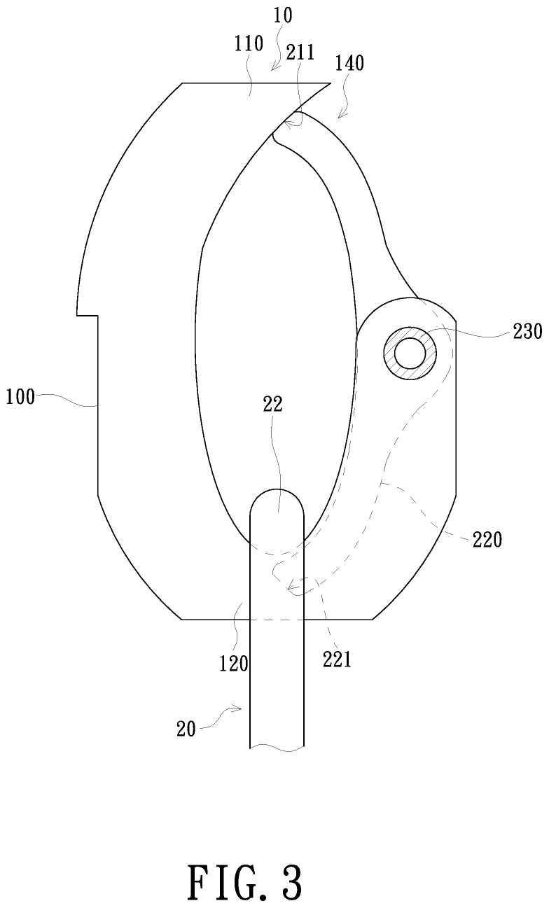

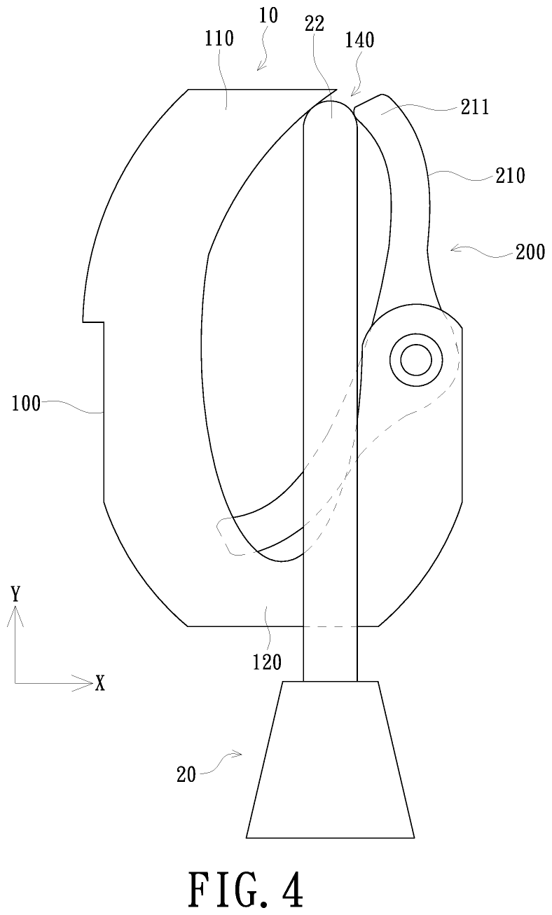

FIG. 3 is a schematic diagram of a hanging structure in a hanging state according to an embodiment of the disclosure. Referring to FIG. 3, when the hanging structure 10 is in the hanging state, the second end 221 is located on an inner side of the bottom 120, for example. The inner side referred to in this embodiment is one side opposite to the hook opening 140. Further, when the hanging structure 10 is in the hanging state and the hanging object 20 is placed into the hanging structure 10, for example, a handle 22 of the hanging object 20 abuts against the inner side of the bottom 120 of the hook-shaped body 100, so that the hook-shaped body 100 bears the weight of the hanging object 20. Meanwhile, in this embodiment, the second end 221 is located on the inner side of the bottom 120, for example, the second end 221 is adjacent to a position where the handle 22 abuts against the inner side of the bottom 120, but does not abut against the handle 22 (that is, the second end 221 is located at a position where the second end 221 is liable to interfere with the handle 22). In another embodiment of the disclosure, the second end 221 may also abut against the handle 22 (that is, the handle 22 interferes with the second end 221), but the disclosure is not limited thereto. It should be noted that the above hanging object 20 is adapted to bear goods within a predetermined weight range, where the goods may, for example, have the handle 22 cooperating with the hook opening 140 and the hook-shaped body 100, or the goods are placed in the hanging object 20, but the disclosure does not specifically limit a weight-bearing manner of the hanging object 20. In addition, when the first end 211 moves slightly in the direction opposite to the abutting portion 110, that is, when the hook opening 140 is slightly opened, the second end 221, for example, will interfere with the handle 22, because the second end 221 is located on the inner side of the bottom 120 and is, for example, adjacent to the position where the handle 22 abuts against the inner side of the bottom 120, and then a spacing between the first end 211 and the abutting portion 110 is limited, that is, an opening degree of the hook opening 140 is limited, so that the opening degree of the hook opening 140 cannot allow the handle 22 to pass through, and the hanging object 20 will not be unhooked. In another embodiment of the disclosure where the second end 221 abuts against the handle 22, when the first end 211 abuts against the abutting portion 110, the second end 221, for example, interferes with the handle 22, so that the hook opening 140 cannot be opened. However, the disclosure is not limited thereto. FIG. 4 is a schematic diagram of switching a hanging structure to be in an unhooking state according to an embodiment of the disclosure. Referring to FIG. 4, when the hanging structure 10 is in an unhooking state, the first end 211 of the first claw portion 210 of the hook claw 200 does not abut against the abutting portion 110 and is adapted to make the handle 22 of the hanging object 20 leave the hanging structure 10 from the hook opening 140. Specifically, when the hanging structure 10 with the hanging object 20 is unloaded, the hanging object 20 is first positioned on the ground because the hanging object 20 is located below the hanging structure 10, but the hanging structure 10 continues to move downwards, so that the handle 22 of the hanging object 20 moves upwards relative to the hanging structure 10, that is, the handle 22 moves in a direction Y from the inner side of the bottom 120 to the abutting portion 110. When the handle 22 moves to the abutting portion 110 and abuts against the first end 211 of the first claw portion 210 of the hook claw 200, the handle 22 is adapted to move the first end 211 of the first claw portion 210 in a direction X away from the abutting portion 110, so that the first end 211 does not abut against the abutting portion 110, and the hook opening 140 is opened. When the opening degree of the hook opening 140 is adapted to make the handle 22 leave the hanging structure 10, the hanging object 20 leaves the hanging structure 10 from the hook opening 140. In other words, the hanging structure 10 is in the unhooking state.

It is worth mentioning that in this embodiment, the second claw portion 220 is heavier than the first claw portion 210. When the handle 22 of the hanging object 20 leaves the hanging structure 10 from the hook opening 140, the second claw portion 220 is pulled by the gravity to move downwards, to drive the hook claw 200 to rotate counterclockwise relative to the hook-shaped body 100, so that the first end 211 of the first claw portion 210 abuts against the abutting portion 110, and the hook opening 140 between the pivoting end 130 and the abutting portion 110 is closed. Therefore, after the hanging structure 10 is unloaded (that is, after the hanging structure 10 is separated from the hanging object 20), the hanging structure 10 does not hook the hanging object 20 again, for example.

In the embodiment of the disclosure, the hanging structure 10 in which the hook opening 140 is kept closed during hanging is used, so that the hanging object 20 is not prone to unhooking, and the hanging object 20 will not be hooked again after unloading.

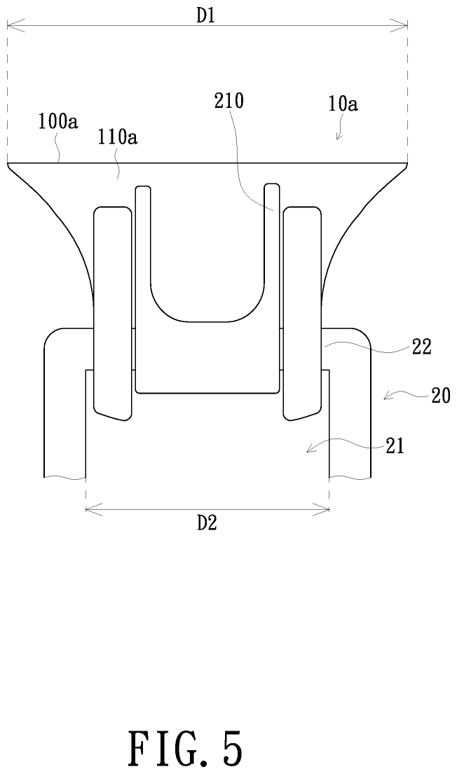

FIG. 5 is a schematic diagram of a hanging structure according to another embodiment of the disclosure. Referring to FIG. 5, a hanging structure 10a in this embodiment is similar to the hanging structure 10 in the previous embodiment, and there is a main difference that an overall width D1 of an abutting portion 110a is increased. For example, the overall width D1 of the abutting portion 110a is, for example, greater than the opening 21 of the handle 22 of the hanging object 20, that is, the overall width D1 of the abutting portion 110a is greater than a horizontal spacing D2 formed by the opening 21. When the hanging object 20 leaves the hanging structure 10a from the hook opening 140 (as shown in FIG. 4) and the hanging structure 10a is in the unhooking state, the opening 21 of the handle 22 cannot pass through the abutting portion 110a, that is, the hanging object 20 can only leave the hook opening 140 from a direction facing and away from the abutting portion 110a, thereby limiting the moving direction of the hanging object 20 when being unhooked. However, the disclosure is not limited thereto.

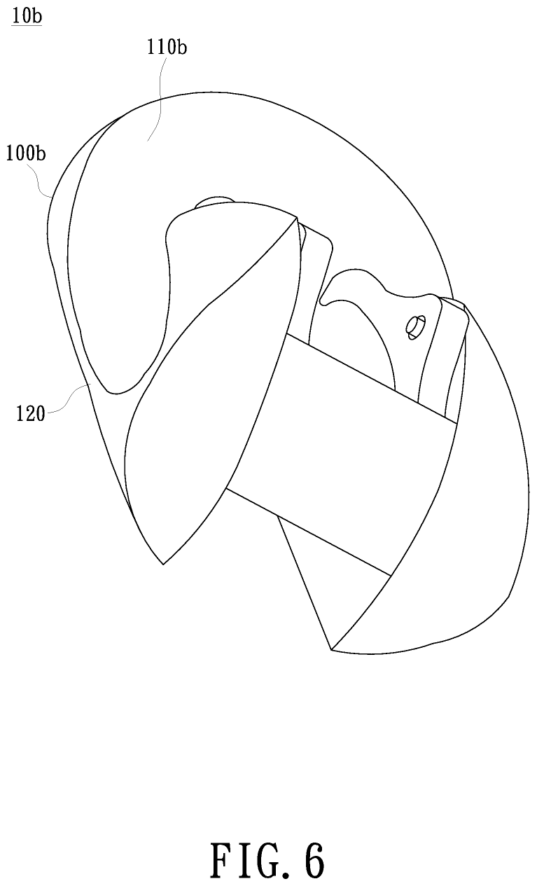

FIG. 6 is a schematic diagram of a hanging structure according to another embodiment of the disclosure. Referring to FIG. 6, in another embodiment of the disclosure, a guide structure may be designed on one side of an abutting portion 110b of a hook-shaped body 100b of a hanging structure 10b that is away from the bottom 120, and is, for example, an elliptical bulge. However, the disclosure is not limited thereto.

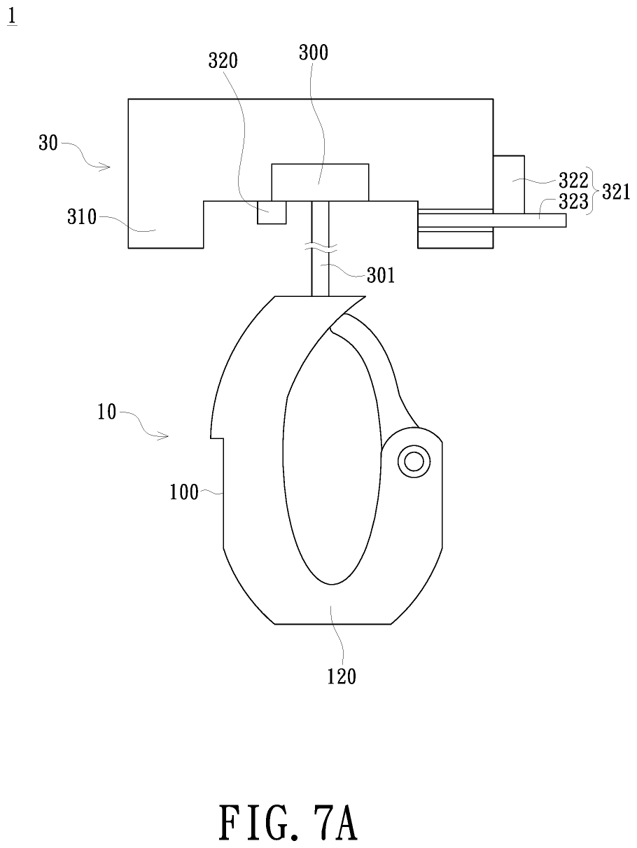

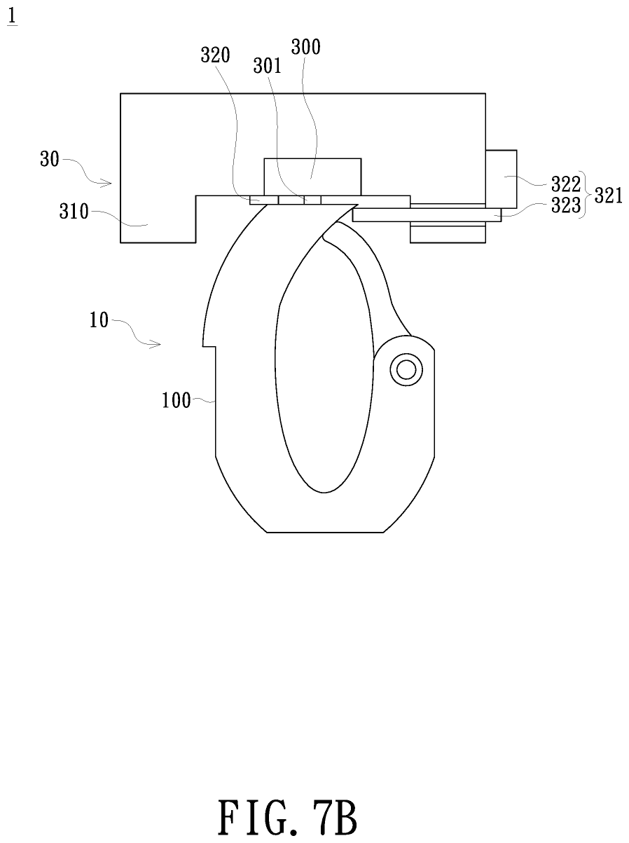

FIG. 7A and FIG. 7B are schematic diagrams of an unmanned aerial vehicle hanging system in a hook releasing state and a hook retracting state respectively according to an embodiment of the disclosure. First, referring to FIG. 7A, the unmanned aerial vehicle hanging system 1 in this embodiment includes the above hanging structure 10 and a retracting and releasing apparatus 30, wherein the retracting and releasing apparatus 30 includes a retracting and releasing mechanism 300 and a connecting piece 301, the retracting and releasing mechanism 300 is adapted to retract and release the connecting piece 301, and the connecting piece 301 is connected to the hook-shaped body 100. Specifically, the retracting and releasing apparatus 30 is arranged, for example, in a belly position of the unmanned aerial vehicle. The retracting and releasing apparatus 30 with the retracting and releasing mechanism 300 is connected to the hook-shaped body 100 in FIG. 1 through the connecting piece 301, that is, the retracting and releasing mechanism 300 adjusts a distance between the retracting and releasing apparatus 30 and the hanging structure 10 by retracting and releasing the connecting piece 301. The above connecting piece 301 connected to the hook-shaped body 100 is, for example, a tether. The hanging structure 10 in this embodiment may alternatively be replaced with the above hanging structure in other embodiments, such as the hanging structure 10a or 10b.

Then, referring to FIG. 7B, the above retracting and releasing apparatus 30 further includes a housing 310, a switch 320, and an anti-falling mechanism 321. The anti-falling mechanism 321 and the retracting and releasing mechanism 300 are arranged in the housing 310, and the switch 320 is arranged on one side of the housing 310 that faces the hanging structure 10 and is electrically connected to the retracting and releasing mechanism 300 and the anti-falling mechanism 321. In the process of retracting the connecting piece 301 by the retracting and releasing mechanism 300, since the first end 211 of the first claw portion 210 always keeps abutting against the abutting portion 110, even if the hanging object 20 is struck to cause the handle 22 of the hanging object 20 to be temporarily floated, the situation that the handle 22 is unhooked to cause the hanging object 20 to fall does not occur. When the retracting and releasing mechanism 300 retracts the connecting piece 301 to cause the hanging structure 10 to trigger the switch 320, the retracting and releasing mechanism 300 stops retracting the connecting piece 301, and the anti-falling mechanism 321 prevents the hanging structure 10 from falling. Meanwhile, the periphery of the housing 310 may also play a role in restricting the first claw portion 210 from opening, thereby avoiding the problem of unhooking. The anti-falling mechanism 321 includes an anti-falling member 323 and a driving member 322, wherein the driving member 322 is electrically connected to the switch 320 and is adapted to drive the anti-falling member 323 to move. For example, when the retracting and releasing mechanism 300 retracts the connecting piece 301 to cause the hanging structure 10 to trigger the switch 320 arranged on the housing 310, a signal provided by the switch 320 is directly or indirectly transmitted to the retracting and releasing mechanism 300, so that the retracting and releasing mechanism 300 stops retracting the connecting piece 301, and the hanging structure 10 is prevented from continuing to move towards the retracting and releasing apparatus 30 to strike the housing 310. Meanwhile, the signal provided by the switch 320 is directly or indirectly transmitted to the anti-falling mechanism 321, so that the driving member 322 of the anti-falling mechanism 321 drives the anti-falling member 323 to move towards the hook-shaped body 100, and relative positions of the hanging structure 10 and the retracting and releasing apparatus 30 are fixed, so the hanging structure 10 is prevented from falling. The above driving member 322 is, for example, a stepper motor, but the disclosure is not limited thereto. The above switch 320 is, for example, a push switch, but may alternatively be a sensing switch (such as a pressure sensing switch and a distance sensing switch). However, the disclosure does not specifically limit the type of the switch.

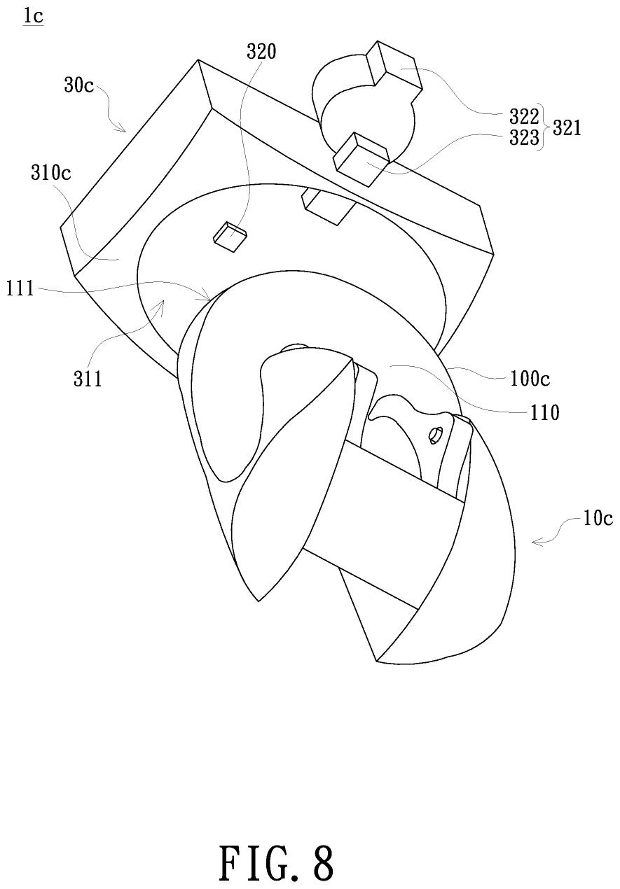

FIG. 8 is a schematic diagram of an unmanned aerial vehicle hanging system according to another embodiment of the disclosure. Referring to FIG. 8, in another embodiment of the disclosure, a first guide portion 311 is arranged on one side of a housing 310c of an unmanned aerial vehicle hanging system 1c that faces a hanging structure 10c, a hook-shaped body 100c further has a second guide portion 111 cooperating with the first guide portion 311, and the second guide portion 111 is adjacent to the abutting portion 110. In addition, for example, the above first guide portion 311 is an elliptical recess, and the second guide portion 111 is an elliptical bulge. In this embodiment, the structural design of the first guide portion 311 and the second guide portion 111 cooperating with the first guide portion 311 helps to guide positioning of the second guide portion 111 of the hanging structure 10c when the retracting and releasing mechanism 300 retracts the hanging structure 10c to the first guide portion 311, so that the anti-falling mechanism 321 can be ensured to prevent the hanging structure 10c from falling according to a predetermined design. In another embodiment of the disclosure, the first guide portion 311 and the second guide portion 111 that cooperate with each other may be of other structure in design, which is not specifically limited in the disclosure.

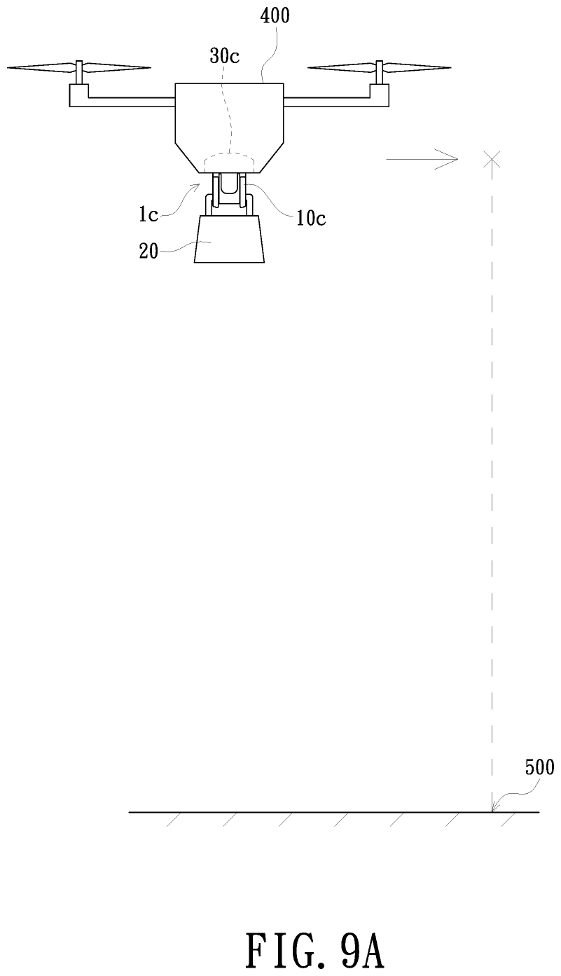

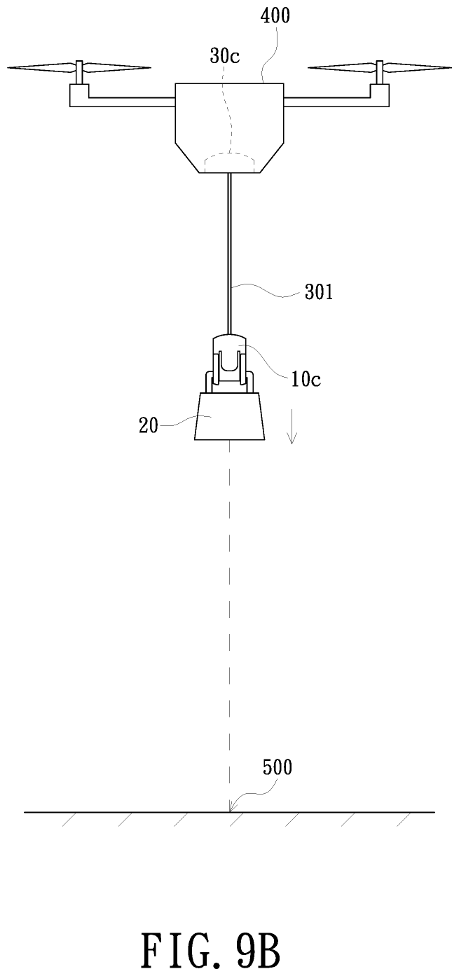

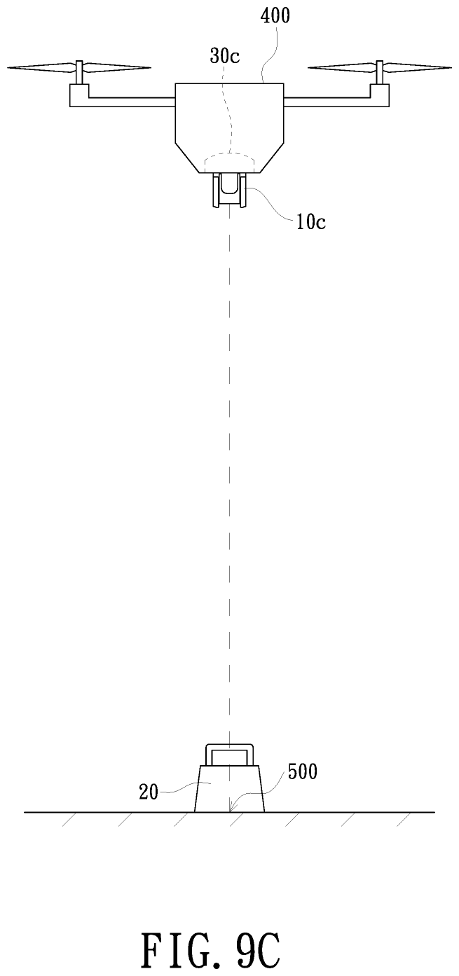

FIGS. 9A to 9C are schematic diagrams of a goods delivery process of an unmanned aerial vehicle according to an embodiment of the disclosure. First, referring to FIG. 9A, the unmanned aerial vehicle 400 has the unmanned aerial vehicle hanging system 1c in FIG. 8, wherein a retracting and releasing apparatus 30c of the unmanned aerial vehicle hanging system 1c is arranged, for example, in a belly of the unmanned aerial vehicle 400, but the disclosure is not limited thereto. When the hanging object 20 is hung on the unmanned aerial vehicle hanging system 1c and the hanging structure 10c is fixed, for example, relative to the retracting and releasing apparatus 30c, the unmanned aerial vehicle 400 flies on the ground and moves toward a target location. For example, the target location is directly above an unloading location 500. Next, referring to FIG. 9B, when the unmanned aerial vehicle 400 moves to the target location, the unmanned aerial vehicle 400, for example, hovers in air, and causes the retracting and releasing apparatus 30c to release the connecting piece 301 in a manner such as remote control, so that the hanging structure 10c and the hanging object 20 move down to the unloading location 500. Finally, referring to FIG. 9C, when the hanging object 20 is placed in the unloading location 500 and the hanging object 20 is unhooked from the hanging structure 10c, the retracting and releasing apparatus 30c of the unmanned aerial vehicle 400, for example, automatically detects that a load of the hanging structure 10c is reduced, and the retracting and releasing apparatus 30c is driven to automatically retract the connecting piece 301 (as shown in FIG. 9B), but the disclosure is not limited thereto. In another embodiment of the disclosure, the retracting and releasing apparatus 30c may retract the connecting piece 301 through remote control, for example. When the connecting piece 301 is being retracted, the unmanned aerial vehicle 400, for example, maintains the hovering state. In other words, the unmanned aerial vehicle 400 is located over the ground of the unloading location 500 and retracts the connecting piece 301, and for example, relative positions of the hanging structure 10c and the retracting and releasing apparatus 30c are fixed.

In the unmanned aerial vehicle hanging system 1 according to the embodiment of the disclosure, the above hanging structure 10 is used, so that the hanging object 20 is not easily unhooked when the unmanned aerial vehicle delivers the hanging object 20, and the hanging object 20 will not be hooked again when the unmanned aerial vehicle retracts the hanging hook after unloading. Therefore, the problem that the hanging object is not easily separated from the hanging structure is solved.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “The disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims. Furthermore, the terms such as the first claw portion, the second claw portion, the first end, the second end, the first guide portion and the second guide portion are only used for distinguishing various elements and do not limit the number of the elements.

What is claimed is:

1. A hanging structure applicable to an unmanned aerial vehicle, the hanging structure comprising:
a hook-shaped body having a bottom, at least one pivoting end, and an abutting portion, wherein a hook opening is provided between the at least one pivoting end and the abutting portion and is opposite to the bottom; and
at least one hook claw having a pivoting portion, and a first claw portion and a second claw portion that extend from the pivoting portion, respectively, wherein the pivoting portion is pivoted to the at least one pivoting end, the second claw portion is heavier than the first claw portion, and when the hanging structure is in a hanging state, a first end of the first claw portion abuts against the abutting portion, and the hook opening is closed.

2. The hanging structure according to claim 1, wherein the second claw portion has a second end, and when the hanging structure is in a hanging state, the second end is located on an inner side of the bottom.

3. The hanging structure according to claim 2, wherein the number of the at least one hook claw is two, the number of the at least one pivoting end is two, and the two second ends of the two hook claws extend towards each other to be connected.

4. The hanging structure according to claim 2, wherein an overall width of the abutting portion of the hook-shaped body is greater than an opening of a handle of a hanging object.

5. The hanging structure according to claim 1, wherein when the hanging structure is in an unhooking state, the first end of the first claw portion does not abut against the abutting portion and is adapted to make a hanging object leave the hanging structure from the hook opening.

6. An unmanned aerial vehicle hanging system, comprising:
a hanging structure, comprising:
a hook-shaped body having a bottom, at least one pivoting end, and an abutting portion, wherein a hook opening is provided between the at least one pivoting end and the abutting portion and is opposite to the bottom; and
at least one hook claw having a pivoting portion, and a first claw portion and a second claw portion that extend from the pivoting portion, respectively, wherein the pivoting portion is pivoted to the at least one pivoting end, the second claw portion is heavier than the first claw portion, and when the hanging structure is in a hanging state, a first end of the first claw portion abuts against the abutting portion, and the hook opening is closed; and
a retracting and releasing apparatus comprising a retracting and releasing mechanism and a connecting piece, wherein the retracting and releasing mechanism is adapted to retract and release the connecting piece, and the connecting piece is connected to the hook-shaped body.

7. The unmanned aerial vehicle hanging system according to claim 6, wherein the second claw portion has a second end, and when the hanging structure is in a hanging state, the second end is located on an inner side of the bottom.

8. The unmanned aerial vehicle hanging system according to claim 7, wherein the number of the at least one hook claw is two, the number of the at least one pivoting end is two, and the two second ends of the two hook claws extend towards each other to be connected.

9. The unmanned aerial vehicle hanging system according to claim 7, wherein an overall width of the abutting portion of the hook-shaped body is greater than an opening of a handle of a hanging object.

10. The unmanned aerial vehicle hanging system according to claim 6, wherein the retracting and releasing apparatus further comprises a housing, a switch, and an anti-falling mechanism, the anti-falling mechanism and the retracting and releasing mechanism are arranged in the housing, the switch is arranged on one side of the housing that faces the hanging structure and is electrically connected to the retracting and releasing mechanism and the anti-falling mechanism, and when the retracting and releasing mechanism retracts the connecting piece to cause the hanging structure to trigger the switch, the retracting and releasing mechanism stops retracting the connecting piece, and the anti-falling mechanism prevents the hanging structure from falling.

11. The unmanned aerial vehicle hanging system according to claim 10, wherein a first guide portion is arranged on the side of the housing that faces the hanging structure, the hook-shaped body further has a second guide portion cooperating with the first guide portion, and the second guide portion is adjacent to the abutting portion.

12. The unmanned aerial vehicle hanging system according to claim 11, wherein the first guide portion is an elliptical recess, and the second guide portion is an elliptical bulge.

13. The unmanned aerial vehicle hanging system according to claim 10, wherein the anti-falling mechanism comprises an anti-falling member and a driving member, and the driving member is electrically connected to the switch and is adapted to drive the anti-falling member to move.
